(19) United States
(12) Patent Application Publication
(10) Pub. No.: US 2024/0421889 A1
(43) Pub. Date: Dec. 19, 2024

(54) CONFIGURATION OF QCL INFORMATION

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, McKinney, TX (US)

(21) Appl. No.: 18/678,478

(22) Filed: May 30, 2024

Related U.S. Application Data
(60) Provisional application No. 63/521,602, filed on Jun. 16, 2023.

(51) Int. Cl. H04B 7/06

(52) U.S. Cl. CPC H04B 7/06968; H04B 7/0626

(57) ABSTRACT

Apparatuses and methods for configuring quasi co-location (QCL) information. A method performed by a user equipment includes receiving a configuration including information about (i) K>1 non-zero power (NZP) channel state information-reference signal (CSI-RS) resources and (ii) quasi-co-location information (QCL-info) that is common for at least N out of the K NZP CSI-RS resources, where 1<N≤K. The QCL-info indicates at least one source RS and a QCL-Type. The QCL-Type indicates at least one channel property of the at least one source RS. The method further includes, based on the configuration, applying the QCL-info for channel measurement via the N out of the K NZP CSI-RS resources based on an assumption that at least one channel property of the N NZP CSI-RS resources is same as the indicated at least one channel property of the at least one source RS.

### CROSS-REFERENCE TO RELATED AND CLAIM OF PRIORITY

The present application claims priority under 35 U.S.C. § 119(e) to U.S. Provisional Patent Application No. 63/521,602 filed on Jun. 16, 2023, which is hereby incorporated by reference in its entirety.

### TECHNICAL FIELD

The present disclosure relates generally to wireless communication systems and, more specifically, the present disclosure is related to apparatuses and methods for configuring quasi co-location (QCL) information.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to configuring QCL information.

In one embodiment, a user equipment (UE) is provided. The UE includes a transceiver configured to receive a configuration including information about (i) K>1 non-zero power (NZP) channel state information-reference signal (CSI-RS) resources and (ii) quasi-co-location information (QCL-info) that is common for at least N out of the K NZP CSI-RS resources, where 1<N≤K. The QCL-info indicates at least one source RS and a QCL-Type. The QCL-Type indicates at least one channel property of the at least one source RS. The UE further includes a processor operably coupled to the transceiver. The processor, based on the configuration, is configured to apply the QCL-info for channel measurement via the N out of the K NZP CSI-RS resources based on an assumption that at least one channel property of the N NZP CSI-RS resources is same as the indicated at least one channel property of the at least one source RS.

In another embodiment, a base station (BS) is provided. The BS includes a processor and a transceiver operably coupled to the processor. The transceiver configured to transmit a configuration including information about (i) K>1 NZP CSI-RS resources and (ii) QCL-info that is common for at least N out of the K NZP CSI-RS resources, where 1<N≤K. The QCL-info indicates at least one source RS and a QCL-Type. The QCL-Type indicates at least one channel property of the at least one source RS. The configuration indicates to apply the QCL-info for channel measurement via the N out of the K NZP CSI-RS resources based on an assumption that at least one channel property of the N NZP CSI-RS resources is same as the indicated at least one channel property of the at least one source RS.

In yet another embodiment, a method performed by a user equipment is provided. The method includes receiving a configuration including information about (i) K>1 NZP CSI-RS resources and (ii) QCL-info that is common for at least N out of the K NZP CSI-RS resources, where 1<N≤K. The QCL-info indicates at least one source RS and a QCL-Type. The QCL-Type indicates at least one channel property of the at least one source RS. The method further includes, based on the configuration, applying the QCL-info for channel measurement via the N out of the K NZP CSI-RS resources based on an assumption that at least one channel property of the N NZP CSI-RS resources is same as the indicated at least one channel property of the at least one source RS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of an antenna port layout according to embodiments of the present disclosure;

FIG. 11 illustrates examples of a UE moving on a trajectory located in co-located and distributed transmit-receive points (TRP) according to embodiments of the present disclosure;

FIG. 12 illustrates a timeline of example spatial-domain (SD) units and frequency-domain (FD) units according to embodiments of the present disclosure; and

FIG. 13 illustrates an example method performed by a UE in a wireless communication system according to embodiments of the present disclosure.

### DETAILED DESCRIPTION

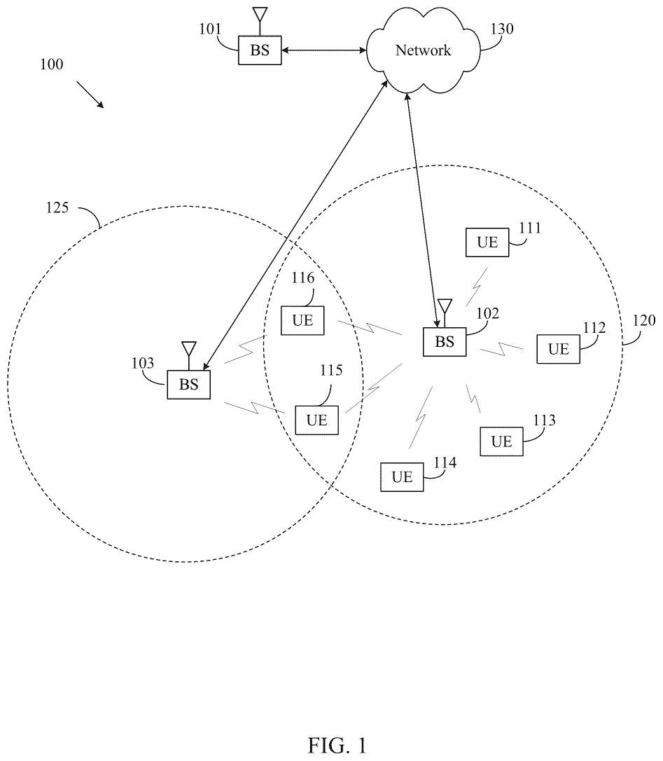

FIGS. 1-13 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 36.211 v17.3.0, “E-UTRA, Physical channels and modulation;” [2] 3GPP TS 36.212 v17.1.0, “E-UTRA, Multiplexing and Channel coding;” [3] 3GPP TS 36.213 v17.3.0, “E-UTRA, Physical Layer Procedures;” [4] 3GPP TS 36.321 v17.3.0, “E-UTRA, Medium Access Control (MAC) protocol specification;” [5] 3GPP TS 36.331 v17.3.0, “E-UTRA, Radio Resource Control (RRC) Protocol Specification;” [6] 3GPP TR 22.891 v1.2.0; [7] 3GPP TS 38.212 v17.3.0, “E-UTRA, NR, Multiplexing and Channel coding;” [8] 3GPP TS 38.214 v17.3.0, “E-UTRA, NR, Physical layer procedures for data;” and [9] 3GPP TS 38.211 v17.3.0, “E-UTRA, NR, Physical channels and modulation.”

FIGS. 1-13 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a Wifi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and utilizing configuration of QCL information. In certain embodiments, one or more of the BSs 101-103 include circuitry, programing, or a combination thereof to support configuring QCL information.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

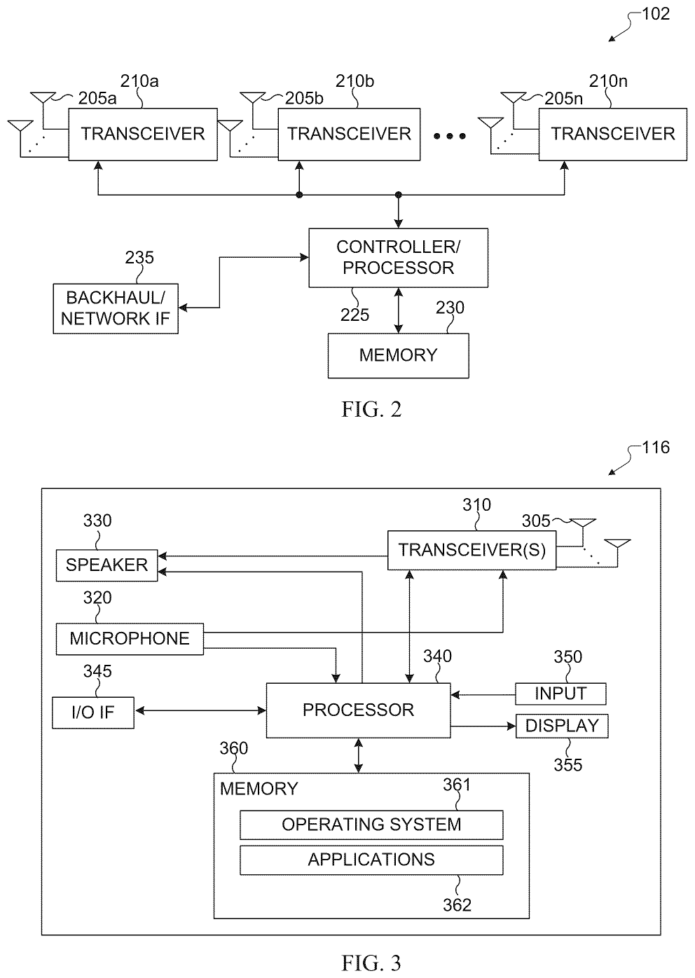

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for configuring QCL information. Any of a wide variety of other functions could be supported in the gNB 102 by the controller/processor 225.

The controller/processor 225 is also capable of executing programs and other processes resident in the memory 230, such as processes to support configuring QCL information. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and utilizing configuration of QCL information as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

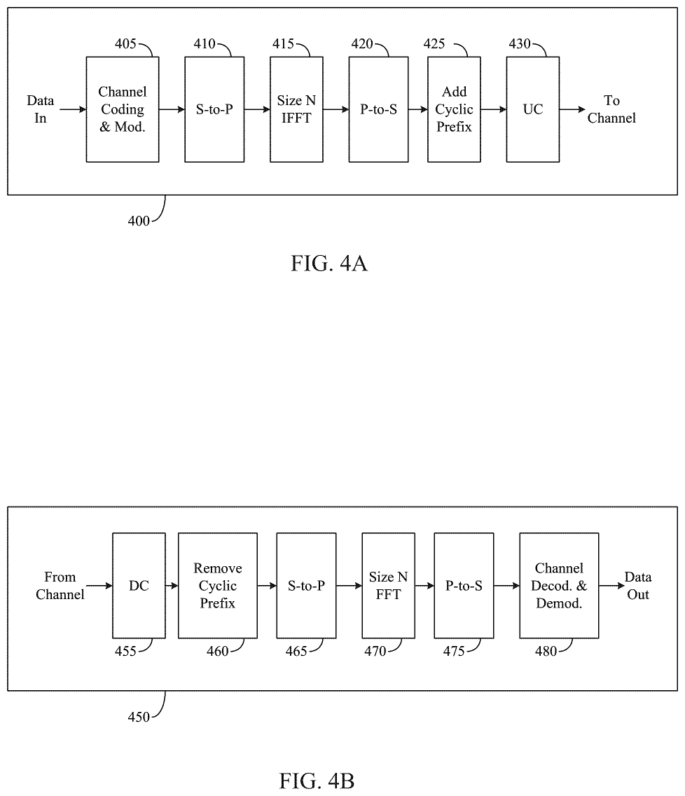

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for identifying and utilizing configuration of QCL information as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

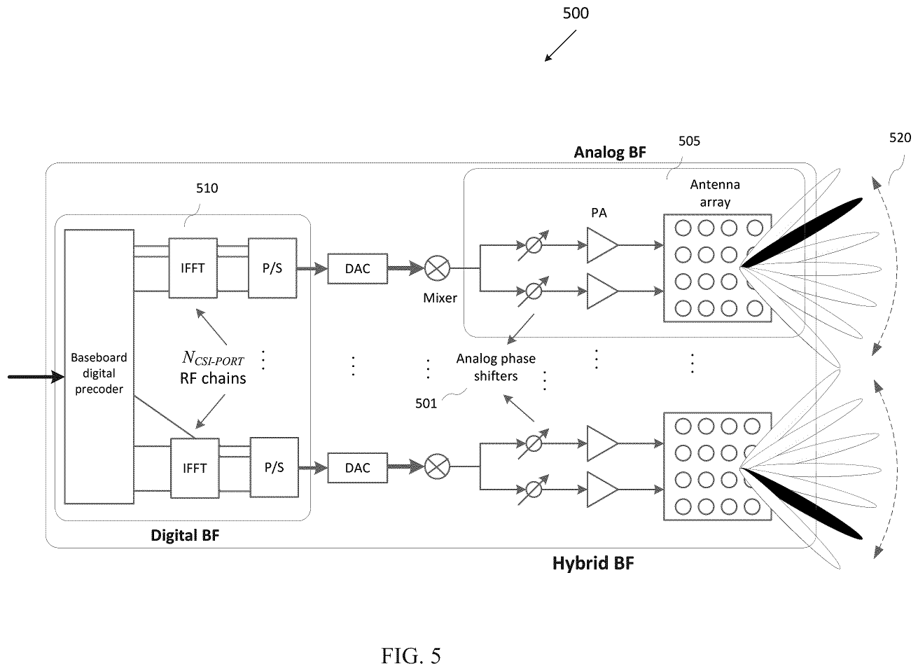

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to QCL configuration.

A communication system includes a downlink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared Channel (PDSCH). An eNodeB transmits DCI through a Physical DL Control Channel (PDCCH) or an Enhanced PDCCH (EPDCCH)—see also document and standard [3]. An eNodeB transmits acknowledgement information in response to data Transport Block (TB) transmission from a UE in a Physical Hybrid Automatic Repeat Request Indicator Channel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A broadcast control channel (BCCH) is mapped to either a transport channel referred to as a Broadcast Channel (BCH) when it conveys a Master Information Block (MIB) or to a DL Shared Channel (DL-SCH) when it conveys a System Information Block (SIB)—see also document and standard [3] and document and standard [5]. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information radio network temporary identifier (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW incudes frequency resource units referred to as Resource Blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or Physical UL Control Channel (PUCCH). An eNodeB can use a DMRS to demodulate data signals or UCI signals. A UE transmits SRS to provide an eNodeB with an UL CSI. A UE transmits data information or UCI through a respective PUSCH or a PUCCH. If a UE requires to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/enhanced PDCCH (EPDCCH) indicating a release of semi-persistently scheduled PDSCH (see also document and standard [3]).

An UL subframe (or slot) includes two slots. Each slot includes N_{symb}^{UL} symbols for transmitting data information, UCI, DMRS, or SRS. A frequency resource unit of an UL system BW is an RB. A UE is allocated N_{RB} RBs for a total of N_{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

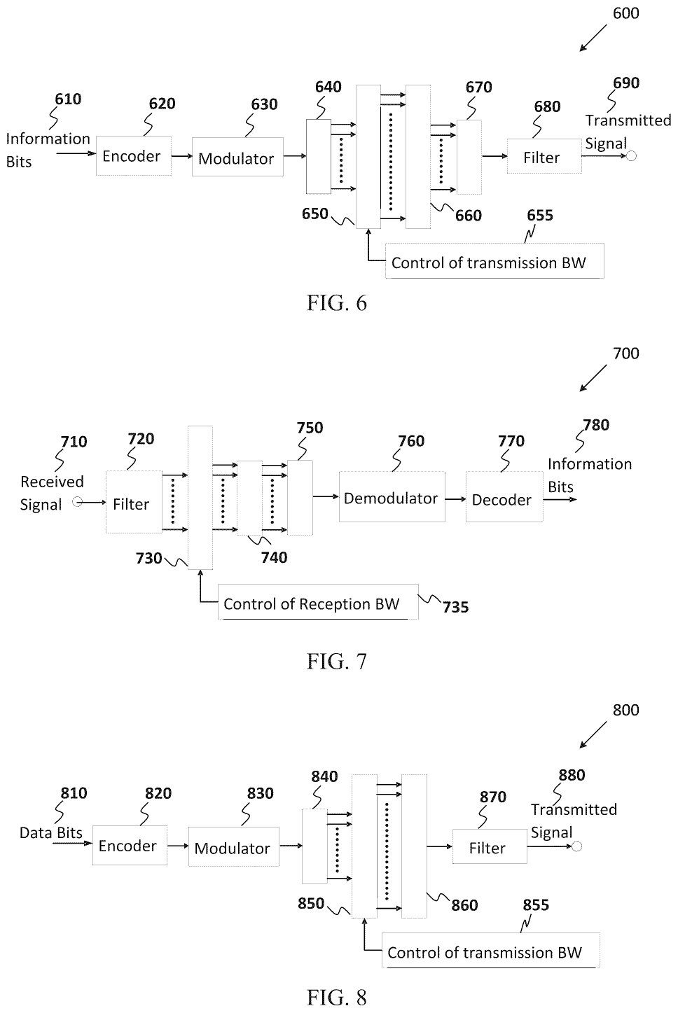

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

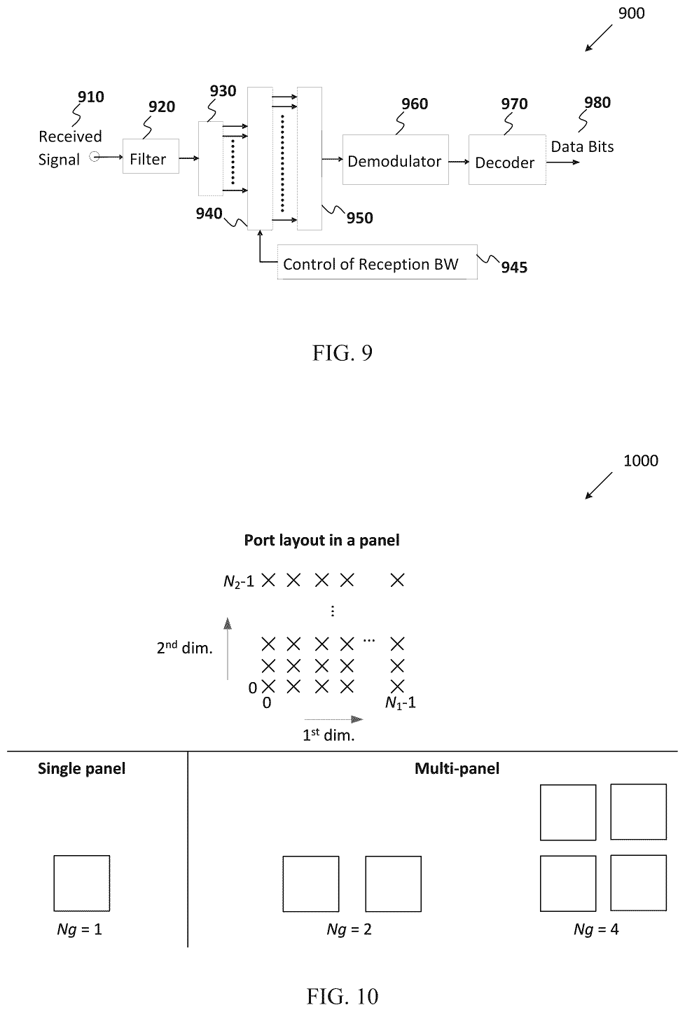

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 1

| Frequency range designation | Corresponding frequency range |
|---|---|
| FR1 | 450 MHz-6000 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be considered, e.g., FR4(>52.6 GHz), terahertz(>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW (e.g., the network 130) deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

In a wireless communication system, MIMO is often identified as an essential feature in order to achieve high system throughput requirements. One of the key components of a MIMO transmission scheme is the accurate CSI acquisition at the eNB (or gNB) (or TRP). For multiuser (MU)-MIMO, in particular, the availability of accurate CSI is necessary in order to guarantee high MU performance. For TDD systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE. In common FDD systems, the CSI feedback framework is ‘implicit’ in the form of rank indicator (RI)/precoding matrix indicator (PMI)/channel quality indicator (CQI) (also CQI report interval (CRI) and layer index (LI)) derived from a codebook assuming SU transmission from eNB (or gNB).

In 5G or NR systems ([document and standard [7], document and standard [8]), the herein-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, embodiments of the present disclosure recognize the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in document and standard [8]). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising each component) requires to be reported by the UE (e.g., the UE 116). However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in document and standard [8]), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (UL-DL channel reciprocity in angular domain), and the beamforming information can be obtained at the gNB 102 based on UL channel estimated using SRS measurements.

In Rel. 17 NR, CSI reporting has been enhanced to support the following:
Further enhanced Type II port selection codebook: it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD or/and M ports are selected in FD. The CSI-RS ports in this case are beamformed in SD (UL-DL channel reciprocity in angular domain) or/and FD (UL-DL channel reciprocity in delay/frequency domain), and the corresponding SD or/and FD beamforming information can be obtained at the gNB 102 based on UL channel estimated using SRS measurements. In Rel. 17, such a codebook is supported (which is referred to as Rel. 17 further enhanced Type II port selection codebook in document and standard [8]).
Non-coherent joint transmission (NCJT) CSI reporting: When the UE can communicate with multiple TRPs that are distributed at different locations in space (e.g., within a cell), the CSI reporting can correspond to a single TRP hypothesis (i.e., CSI reporting for one of the multiple TRPs) or multi-TRP hypothesis (i.e., CSI reporting for at least two of the multiple TRPs). The CSI reporting for both single TRP and multi-TRP hypotheses are supported in Rel. 17. However, the multi-TRP CSI reporting imply a NCJT, i.e., a layer (and precoder) of the transmission is restricted to be transmitted from only one TRP.

In Rel. 18 MIMO WID includes the following objectives on CSI enhancements:
Study, and if justified, specify enhancements of CSI acquisition for Coherent-JT targeting FR1 and up to 4 TRPs, implying ideal backhaul and synchronization as well as the same number of antenna ports across TRPs, as follows:
   Rel-16/17 Type-II codebook refinement for coherent joint transmission (CJT) multi-TRP (mTRP) targeting FDD and its associated CSI reporting, taking into account throughput-overhead trade-off.
Study, and if justified, specify CSI reporting enhancement for high/medium UE velocities by exploiting time-domain correlation/Doppler-domain information to assist DL precoding, targeting FR1, as follows:
   Rel-16/17 Type-II codebook refinement, without modification to the spatial and frequency domain basis
   UE reporting of time-domain channel properties measured via CSI-RS for tracking

Although Rel-18 CJT CSI can support up to 128 antenna ports by configuring 4 CSI-RS resources each with 32 antenna ports, there is another interest arising to support up to 128 antenna ports using Type-I CSI, which requires smaller feedback overhead than Rel-18 CJT CSI. Currently, a single CSI-RS resource can support up to 32 antenna ports for Type-I single-panel (SP) and multi-panel (MP) CSI. By using multiple CSI-RS resources for Type-I CSI, it is allowed to configure up to 64 antenna ports according to one of the following two schemes:
Two CSI-RS resources each with 32 antenna ports for Rel-17 NCJT (which is Type-I CSI-based)
8 CSI-RS resources each with 8 antenna ports for Type-I SP CSI or Type-I MP CSI

However, both of the schemes do not offer CSI feedback associated with the entire channel of 64 antenna ports, but are designed for specific use cases, 1) NCJT from two TRP, and 2) one CSI-RS resource selection and reporting associated with the selected CSI-RS resource, respectively. Hence, embodiments of the present disclosure recognize Type-I CSI with more than 32 antenna ports is limited in terms of use cases, and needs some enhancement.

In next generation MIMO systems, the number of antenna ports is expected to increase further (e.g., up to 256), for example, for carrier frequencies in upper mid-band (10-15 GHz); the NW (e.g., the network 130) deployments are likely to be denser/more distributed (when compared with 5G NR); and the system is expected to work seamlessly even in challenging scenarios such as medium-high (e.g., 120 kmph) speed UEs, ‘higher-order) multi-user MIMO.

Similar to common (Rel. 15/18 NR) both low-resolution (aka Type I) and high-resolution (aka Type II) CSI reporting for the distributed systems mentioned herein are needed and beneficial depending on use cases and scenarios. Unlike the common, however, it is preferable to have a common framework or components between the two CSI reporting settings, in order to have a simple, future-proof, and scalable solution, thereby making it more feasible in real deployments.

In this disclosure, a framework for such CSI reporting is provided that is based on Rel. 16 enhanced Type II and Rel. 18 Type II CJT codebooks. In particular, based on the provided framework, several examples are provided to facilitate the low-resolution (aka Type I) CJT CSI reporting across multiple antenna port groups or NZP CSI-RS resources.

The present disclosure relates to a CSI reporting framework in next generation MIMO systems. In particular, it relates to the CSI reporting based on a low-resolution (or Type I) or high-resolution (aka Type II) codebook comprising spatial-, frequency- or/and time-(Doppler-)domain components for a mTRP CJT with distributed antenna structure (DMIMO). The 3 most novel aspects are as follows:
QCL assumptions for K>1 NZP CSI-RS resources for three use cases; (1) co-located deployment of antenna groups (hence, resources) requiring single/common QCL across resources, (2) non-co-located/distributed deployment of each antenna group (hence each resource) requiring independent QCL across resources, and (3) non-co-located/distributed deployment of multiple antenna groups (hence resource groups) requiring independent QCL across resource groups.
Signaling/configuration for one of the three use cases
QCL-types and resources
Applicability to different codebooks and number of CSI-RS ports

Aspects, features, and advantages of the present disclosure are readily apparent from the following detailed description, simply by illustrating a number of particular embodiments and implementations, including the best mode contemplated for carrying out the present disclosure. Embodiments of the present disclosure also capable of other and different embodiments, and its several details can be modified in various obvious respects, all without departing from the spirit and scope of the present disclosure. Accordingly, the drawings and description are to be regarded as illustrative in nature, and not as restrictive. Embodiments of the present disclosure are illustrated by way of example, and not by way of limitation, in the figures of the accompanying drawings.

In the following, for brevity, both FDD and TDD are regarded as the duplex method for both DL and UL signaling.

Although exemplary descriptions and embodiments to follow imply orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure covers several components which can be used in conjunction or in combination with one another or can operate as standalone schemes.

Each of the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, each of the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include each of the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz large system bandwidth may be called for multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for each of the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 10 illustrates a diagram of an antenna port layout 1000 according to embodiments of the present disclosure. For example, antenna port layout 1000 of an antenna port layout can be implemented by the BS 102 of FIG. 2. This example is for illustration only and can be used without departing from the scope of the present disclosure.

With reference to FIGS. 10, N₁ and N₂ are the number of antenna ports with the same polarization in the first and second dimensions, respectively. For 2D antenna port layouts, N₁>1, N₂>1, and for 1D antenna port layouts N₁>1 and N₂=1. So, for a dual-polarized antenna port layout, the total number of antenna ports is 2N₁N₂ when each antenna maps to an antenna port. “X” represents two antenna polarizations. In the present disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna payouts are assumed in this disclosure. The embodiments (and examples) in this disclosure however are general and are applicable to single-polarized antenna layouts as well.

Let N_{g} be a number of antenna groups (AGs). With reference to FIG. 10, when there are multiple antenna groups (N_{g}>1), each group (g∈{1, . . . , N_{g}}) comprises dual-polarized antenna ports with N_{1,g} and N_{2,g} ports in two dimensions. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g} (for co-polarized or dual-polarized respectively).

In one example, an antenna group corresponds to an antenna panel. In one example, an antenna group corresponds to a TRP. In one example, an antenna group corresponds to a remote radio head (RRH). In one example, an antenna group corresponds to CSI-RS antenna ports of a NZP CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g., comprising a CSI-RS resource set).

In one example, an antenna group corresponds to a reconfigurable intelligent surface (RIS) in which the antenna group can be (re-)configured more dynamically (e.g., via MAC CE or/and DCI). For example, the number of antenna ports associated with the antenna group can be changed dynamically.

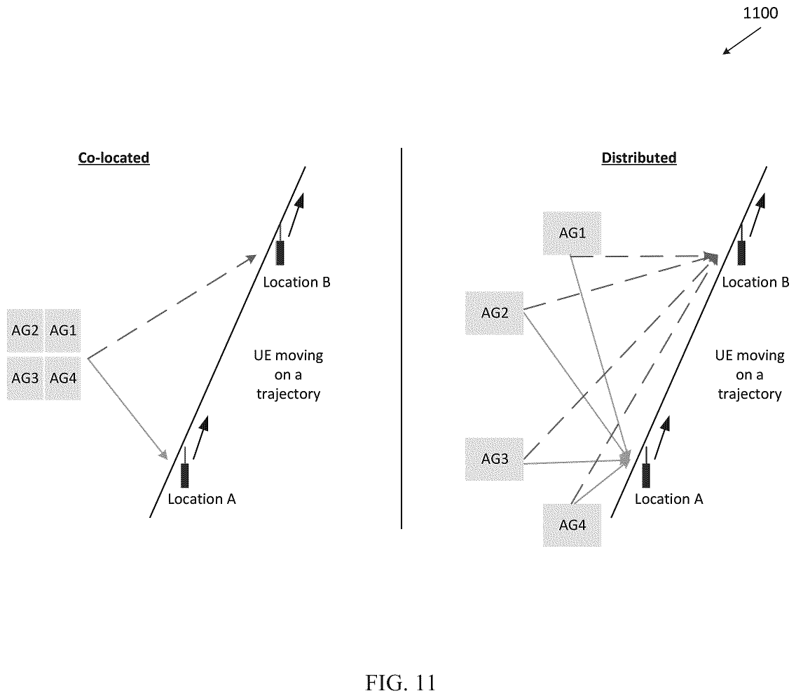

In one example scenario, with reference to FIG. 11, multiple AGs can be co-located or distributed, and can serve static (non-mobile) or moving UEs. An illustration of AGs serving a moving UE is shown. While the UE moves from a location A to another location B, the UE measures the channel, e.g., via NZP CSI-RS resources, (may also measure the interference, e.g., via CSI interference measurement (CSI-IM) resources or CSI-RS resources for interference measurement), uses the measurement to determine/report CSI considering joint transmission from multiple AGs. The reported CSI can be based on a codebook. The codebook can include components considering multiple AGs, and frequency/delay-domain channel profile and time/Doppler-domain channel profile.

In one example, the antenna architecture of the MIMO system is structured. For example, the antenna structure at each AG is dual-polarized (single or multi-panel as shown in FIG. 10). The antenna structure at each AG can be the same. Or the antenna structure at an AG can be different from another AG. Likewise, the number of ports at each AG can be the same. Or the number of ports at one AG can be different from another AG.

In another example, the antenna architecture of the MIMO system is unstructured. For example, the antenna structure at one AG can be different from another AG.

In various embodiments, a structured antenna architecture is presumed. For simplicity, each AG may be equivalent to a panel (cf. FIG. 10), although, an AG can have multiple panels in practice. The disclosure however is not restrictive to a single panel assumption at each AG, and can easily be extended (covers) the case when an AG has multiple antenna panels.

FIG. 11 illustrates examples of a UE moving on a trajectory 1100 located in co-located and distributed TRPs according to embodiments of the present disclosure. For example, trajectory 1100 located in co-located and distributed TRPs can be implemented by any of the UEs 111-116 of FIG. 1. This example is for illustration only and can be used without departing from the scope of the present disclosure.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein.
In one example, an AG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g., an RRC parameter). Or it can be implicit.
   In one example, when implicit, it could be based on the value of K. For example, when K>1 CSI-RS resources, an AG corresponds to one or more examples described herein. For example, when K=1 CSI-RS resource, an AG corresponds to one or more examples described herein.
   In another example, the configuration could be based on the configured codebook. For example, an AG corresponds to a CSI-RS resource or resource group according to one or more examples described herein when the codebook corresponds to a decoupled codebook (modular or separate codebook for each AG), and an AG corresponds to a subset (or a group) of CSI-RS ports when codebook corresponds to a coupled (joint or coherent) codebook (one joint codebook across AGs).

In one example, when AG maps (or corresponds to) a CSI-RS resource or resource group, and a UE can select a subset of AGs (resources or resource groups) and report the CSI for the selected AGs (resources or resource groups), the selected AGs can be reported via an indicator. For example, the indicator can be a CRI or a PMI (component) or a new indicator.

In one example, when AG maps (or corresponds to) a CSI-RS port group, and a UE can select a subset of AGs (port groups) and report the CSI for the selected AGs (port groups), the selected AGs can be reported via an indicator. For example, the indicator can be a CRI or a PMI (component) or a new indicator.

In one example, when multiple (K>1) CSI-RS resources are configured for N_{g} AGs, a decoupled (modular) codebook is used/configured and, when a single (K=1) CSI-RS resource for N_{g} AGs, a joint codebook is used/configured.

In this disclosure, notations N_{g}, N_{TRP}, and K have been used interchangeably to denote the number of AGs or TRPs or CSI-RS resources (in one CSI resource set) that are linked to a CSI report (as described later).

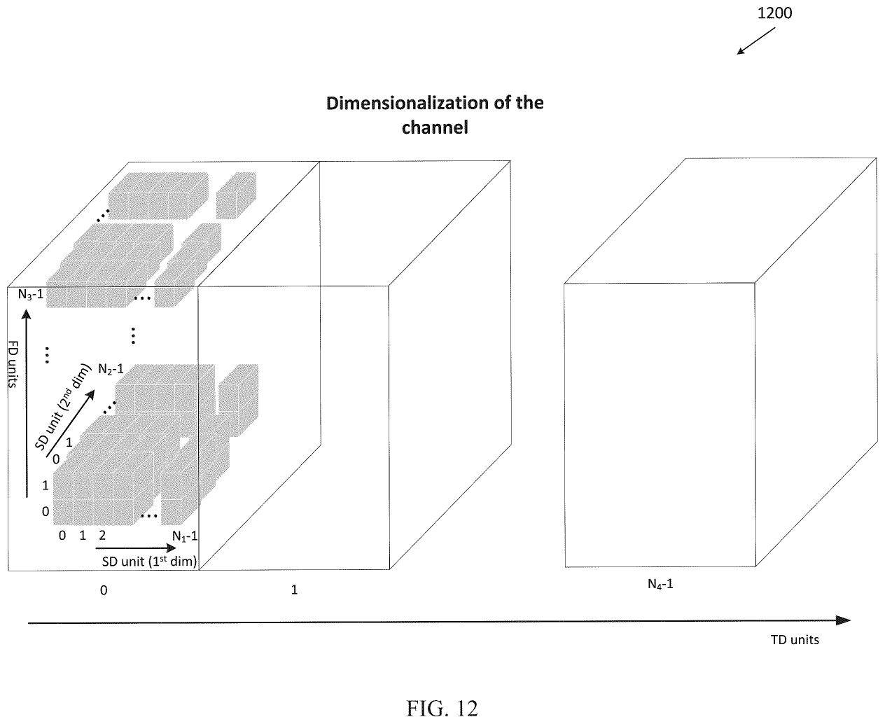

FIG. 12 illustrates a timeline 1200 of example SD units and FD units according to embodiments of the present disclosure; For example, timeline 1200 of example SD units and FD units can be followed by any of the UEs 111-116 of FIG. 1. This example is for illustration only and other embodiments can be used without departing from the scope of the present disclosure.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

The CSI reporting can be based on the channel measurement via K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

With reference to FIG. 12, an illustration of the SD units (in 1^{st} and 2^{nd} antenna dimensions), FD units, and, and TD units is shown.
The first dimension is associated with the 1st antenna port dimension and comprises N₁ units;
The second dimension is associated with the 2nd antenna port dimension and comprises N₂ units;
The third dimension is associated with the frequency dimension and comprises N₃ units; and
The fourth dimension is associated with the time/Doppler dimension and comprises N₄ units.

The plurality of SD units can be associated with antenna ports (e.g., co-located at one site or distributed across multiple sites) comprising one or multiple antenna groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one AG comprising P_{CSIRS} ports, and the CSI report is based on the channel measurement from the one AG.
When N_{g}>1, there are multiple AGs, and the CSI report is based on the channel measurement from/across the multiple AGs.

When K>1, there are multiple CMRs, and the CSI report is based on the channel measurement across the multiple CMRs. In one example, a CMR corresponds to an AG (one-to-one mapping). In one example, multiple CMRs can correspond to an AG (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g., via higher layer RRC parameter. Or it can be indicated via a MAC CE. Or it can be provided via a DCI field.

Likewise, the value of K can be configured, e.g., via higher layer RRC parameter. Or it can be indicated via a MAC CE. Or it can be provided via a DCI field.

In one example, K=N_{g}=X. The value of X can be configured, e.g., via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

The CSI report includes an information about a precoding matrix (e.g., the information is an indicator such as PMI). The information about the precoding matrix comprises/includes at least two components (W₁ and W₂). The first component (W₁) includes a basis which corresponds to a set of basis entities (e.g., DFT vectors). The second component (W₂) includes:
For low-resolution (Type I), selection of a basis entity (e.g., a DFT vector) from the basis entities (per layer) and co-phasing across two polarizations.
For high-resolution (Type II), combining coefficients which linearly combine the basis entities, i.e., the precoding matrix can be represented as a weighted summation over the basis entities, where the weights are the combining coefficients.

The first component W₁ is codebook-based. When the basis needs reporting (or configured to be reported), the codebook configured for the CSI report includes at least one component for reporting the basis W₁. This component is similar to common (e.g., Type I and II codebooks in 5G NR) codebooks. However, since W₁ is decoupled from W₂, the framework allows more options and parameterization for the W₁ basis as future upgrades when newer antenna types become available. The basis can be dictated by (or associated with) at least one of the spatial-domain profile, frequency (or delay)-domain profile, or time (Doppler)-domain profile of the channel measurement. Even though the number of CSI-RS antenna ports can be large (e.g., 256), the antenna ports are expected to have some antenna structure (e.g., similar to 2D active antenna array). Hence, the SD channel profile can be represented using SD basis entities, where the SD basis entities have dimension depending on the number of SD units (P_{CSIRS} or

$$\frac{{P}_{CSIRS}}{2}$$

or 2N₁N₂ or N₁N₂). Likewise, the FD channel profile is likely to be correlated across FD units, and the division duplexing (DD)/time division (TD) channel profile is also expected to have some correlation across DD/TD units (e.g., for low-medium speed UEs). Hence, FD and DD/TD channel profiles can be represented using FD and DD/TD basis entities, respectively, where their dimensions depend on the number of FD units (N₃) and the number of DD/TD units (N₄), respectively.

The second component (W₂) is also codebook-based and is derived based on the channel measurement and W₁. For instance, the channel measurement can be projected on to the basis W₁ and projected channel can be used to derive the W₂ components (coefficients), e.g., based on Type I or Type II codebooks in 5G NR.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is P_{CSIRS,tot}=Σᵣ₌₁^{K}2N_{1,r}N_{2,r}.

In port numbering scheme 1, the CSI-RS ports are numbered according to the order of (polarization p, NZP CSI-RS resource r) as CSI-RS ports of (p=0, r=1) followed by CSI-RS ports of (p=1, r=1), followed by CSI-RS ports of (p=0, r=2), followed by CSI-RS ports of (p=1, r=2), . . . , followed by CSI-RS ports of (p=0, r=N) followed by CSI-RS ports of (p=1, r=N).

In port numbering scheme 2, the CSI-RS ports are numbered according to the order of (polarization p, NZP CSI-RS resource r) as:
CSI-RS ports of (p=0, r=1) followed by CSI-RS ports of (p=0, r=1), . . . , followed by CSI-RS ports of (p=0, r=N); and
then CSI-RS ports of (p=1, r=1) followed by CSI-RS ports of (p=1, r=1), . . . , followed by CSI-RS ports of (p=1, r=N).

In one embodiment, a UE is configured with a CSI report associated with (or across) N≥1 NZP CSI-RS resources (or N≥1 subsets of CSI-RS antenna ports or antenna port groups within a NZP CSI-RS resource). The CSI report is determined based on a codebook comprising components corresponding to W₁ and W₂. In particular, the precoder for layer l is given by

$${W}_{l} = \frac{1}{γ} {W}_{1} {W}_{2}$$

### Here,

Wₗ is a P_{CSIRS}×1 vector, where P_{CSIRS}=Σᵣ₌₁^{N}2N_{1,r}N_{2,r}
W₁ is a block diagonal matrix comprising 2N blocks, where two blocks are associated with two antenna polarizations (two halves or groups of CSI-RS antenna ports) of each NZP CSI-RS resource and each block is a

$$\frac{{P}_{CSIRS , r}}{2} \times {L}_{r}$$

SD basis or port selection matrix (similar to Rel. 16 Type I or Rel. 16/18 Type II or Type II CJT codebook or Rel. 17/18 Type II port selection (PS) or CJT PS codebook)
W₂ is a 2L×2N coefficients matrix, where L=Σᵣ₌₁^{N}Lᵣ, and
γ is a normalization factor.

In one example, N≤K and K is a number of NZP CSI-RS resources (e.g., in a CSI resource set) configured for channel measurements. In one example, K is fixed (e.g., 2 or 3 or 4) or configured (e.g., via higher layer from {2,3,4} or {1,2,3,4}), or reported by the UE (e.g., as part of UE capability). In one example, the value of N can be ≥1. In one example, the value of N can be ≥2. In one example, the value of N is configured (e.g., via higher layer). In one example, the value of N is reported by the UE (e.g., as part of the CSI report). In one example, the UE (e.g., the UE 116) is configured with N=K (i.e., no selection of NZP CSI-RS resources) or N≤K (i.e., dynamic selection of NZP CSI-RS resources by the UE). When the UE performs dynamic selection, the selected N NZP CSI-RS resources can be reported via part 1 of the two part CSI (or UCI). The reporting can be via a bitmap indicator of size K bits.

In one example, for port numbering scheme 1, W₁ is a block diagonal matrix

$$[ \begin{matrix}\begin{matrix}{W}_{1 , 1} & 0 \\ 0 & ⋰\end{matrix} & \begin{matrix}0 & 0 \\ 0 & 0\end{matrix} \\ \begin{matrix}0 & 0 \\ 0 & 0\end{matrix} & {W}_{1 , 2 N}\end{matrix} ]$$

comprising 2N blocks, where (2(r−1)+1,2r)-th blocks, W_{1,2(r-1)+1} and W_{1,2r}, are associated with two antenna polarizations (two halves or groups of CSI-RS antenna ports) of the NZP CSI-RS resource r. For Type I, W₂ is a block matrix

$$[ \begin{matrix}{W}_{2 , 1} \\ {W}_{2 , 2} \\ ⋮ \\ {W}_{2 , 2 N}\end{matrix} ]$$

and

$$[ \begin{matrix}{W}_{2 , 2 ( r - 1 ) + 1} \\ {W}_{2 , 2 r}\end{matrix} ] = {W}_{2 , r , 1} {W}_{2 , r , 2} = [ \begin{matrix}{e}_{{j}_{r}}^{{L}_{r}} & 0 \\ 0 & {e}_{{j}_{r}}^{{L}_{r}}\end{matrix} ] [ \begin{matrix}1 \\ {c}_{r}\end{matrix} ] = [ \begin{matrix}{e}_{{j}_{r}}^{{L}_{r}} \\ {c}_{r} {e}_{{j}_{r}}^{{L}_{r}}\end{matrix} ] ,$$

eⱼ_{ᵣ}^{L}^{ᵣ} is a Lᵣ-element column (selection) vector containing a value of 1 in element jᵣ or (jᵣ mod Lᵣ) and zeros elsewhere, and cᵣ is a coefficient. Note that when Lᵣ=1,

$${W}_{2 , r , 1} = [ \begin{matrix}1 & 0 \\ 0 & 1\end{matrix} ] ,$$

hence eⱼ_{ᵣ}^{L}^{ᵣ} does not need reporting. Hence, eⱼ_{ᵣ}^{L}^{ᵣ} is reported when Lᵣ>1. For Type II, W₂ is a 2L×1 vector which linearly (sums) combines the 2L basis vectors (cf. Rel. 15/16/17 Type II W2).

In one example, for port numbering scheme 2, W₁ is a block diagonal matrix

$$[ \begin{matrix}{W}_{1 , 1} & 0 & 0 & 0 \\ 0 & ⋱ & 0 & 0 \\ 0 & 0 & & \\ 0 & 0 & & {W}_{1 , 2 N}\end{matrix} ]$$

comprising 2N blocks, where (r,r+N)-th blocks, W_{1,r} and W_{1,r+N}, are associated with two antenna polarizations (two halves or groups of CSI-RS antenna ports) of the NZP CSI-RS resource r. For Type I, W₂ is a block matrix

$$[ \begin{matrix}{W}_{2 , 1} \\ {W}_{2 , 2} \\ ⋮ \\ {W}_{2 , 2 N}\end{matrix} ]$$

and

$$[ \begin{matrix}{W}_{2 , r} \\ {W}_{2 , r + N}\end{matrix} ] = {W}_{2 , r , 1} {W}_{2 , r , 2} = [ \begin{matrix}{e}_{{j}_{r}}^{{L}_{r}} & 0 \\ 0 & {e}_{{j}_{r}}^{{L}_{r}}\end{matrix} ] [ \begin{matrix}1 \\ {c}_{r}\end{matrix} ] = [ \begin{matrix}{e}_{{j}_{r}}^{{L}_{r}} \\ {c}_{r} {e}_{{j}_{r}}^{{L}_{r}}\end{matrix} ] ,$$

eⱼ_{ᵣ}^{L}^{ᵣ} is a Lᵣ-element column (selection) vector containing a value of 1 in element jᵣ or (jᵣ mod Lᵣ) and zeros elsewhere, and cᵣ is a coefficient. Note that when Lᵣ=1,

$${W}_{2 , r , 1} = [ \begin{matrix}1 & 0 \\ 0 & 1\end{matrix} ] ,$$

hence eⱼ_{ᵣ}^{L}^{ᵣ} does not need reporting. Hence, eⱼ_{ᵣ}^{L}^{ᵣ} is reported when Lᵣ>1. For Type II, W₂ is a 2L×1 vector which linearly (sums) combines the 2L basis vectors (cf. Rel. 15/16/17 Type II W2).

For each CSI-RS resource r=1, . . . , N,

$$[ \begin{matrix}{W}_{1 , 2 ( r - 1 ) + 1} & 0 \\ 0 & {W}_{1 , 2 r}\end{matrix} ] = [ \begin{matrix}{B}_{r} & 0 \\ 0 & {B}_{r}\end{matrix} ] or [ \begin{matrix}{W}_{1 , r} & 0 \\ 0 & {W}_{1 , r + N}\end{matrix} ] = [ \begin{matrix}{B}_{r} & 0 \\ 0 & {B}_{r}\end{matrix} ]$$

is a P_{CSIRS,r}×2Lᵣ SD basis matrix, where the Lᵣ SD basis vectors comprising columns of Bᵣ are determined the same way as in Rel. 15 Type I or Rel. 15/16/17 Type II codebooks (cf. 5.2.2.2.1/2/3, REF 8).

For a given antenna port layout (N₁, N₂) and oversampling factors (O₁, O₂) for two dimensions, a DFT vector v_{l,m} can be expressed as follows.

$${v}_{l , m}^{{N}_{1} , {N}_{2}} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$${u}_{m}^{{N}_{2}} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0,1, . . . , O₁N₁−1} and m∈{0,1, . . . , O₂N₂−1}. Here, (O₁, O₂) can be fixed, e.g. (1,1), (2,2), (2,1), (2,2), (4,1), or (4,4), or configured. (O₁, O₂) can be different across resources. (O₁, O₂) can depend on (N₁, N₂). For example, OᵢNᵢ=v or ≤v where v can be fixed, e.g., 64, 128 or configured.

Let P_{CSIRS,r}=2N_{1,r}N_{2,r} be number of CSI-RS ports associated with CSI-RS resource r. Let K=M₁M₂ be a total number of resources or port groups, where Mᵢ is a number of resources in i-th dimension, and i=1,2. In one example, the UE is configured with one of the following:
In one example, the UE is configured with K or (M₁, M₂), and P_{CSIRS,r}.
In one example, the UE is configured with K or (M₁, M₂), and P_{CSIRS}.
In one example, the UE is configured with P_{CSIRS}, and P_{CSIRS,r}.
In one example, the UE is configured with K or (M₁, M₂), P_{CSIRS,r} and P_{CSIRS}.

In one example, the UE is configured with one of the parameters herein from a set of supported combinations of values, which can be each of or a subset of the combinations shown in Table 2.

TABLE 2

| Number of | | |
|---|---|---|
| CSI-RS antenna | | Number of resources: |
| ports, P_{CSI-RS} | (N₁, N₂) | M₁ × M₂, (M₁, M₂) |
| 4 | (2, 1) | |
| 8 | (2, 2) | |
| | (4, 1) | |
| 12 | (3, 2) | |
| | (6, 1) | |
| 16 | (4, 2) | |
| | (8, 1) | |
| 24 | (4, 3) | |
| | (6, 2) | |
| | (12, 1) | |
| 32 | (4, 4) | |
| | (8, 2) | |
| | (16, 1) | |
| 64 | P_{CSIRS,r} = 2: (1, 1) | (32, 1), (16, 2), (8, 4), |
| | | (4, 8)(2, 16), (1, 32) |
| | P_{CSIRS,r} = 4: (2, 1) | (16, 1), (8, 2), (4, 4), |
| | | (2, 8)(1, 16) |
| | P_{CSIRS,r} = 8: (2, 2), | (8, 1), (4, 2), (2, 4), (1, 8) |
| | (4, 1) | |
| | P_{CSIRS,r} = 16: | (4, 1), (2, 2), (1, 4) |
| | (4, 2), (8, 1) | |
| | P_{CSIRS,r} = 32: | (2, 1), (1, 2) |
| | (4, 4), (8, 2), (16, 1) | |
| 96 | P_{CSIRS,r} = 2: (1, 1) | (48, 1), (24, 2), (16, 3), |
| | | (12, 4), (8, 6), (6, 8), |
| | | (4, 12), (3, 16), (2, 24), (1, 48) |
| | P_{CSIRS,r} = 4: (2, 1) | (24, 1), (12, 2), (8, 3), (6, 4), |
| | | (4, 6), (3, 8), (2, 12), (1, 24) |
| | P_{CSIRS,r} = 8: (2, 2), | (12, 1), (6, 2), (4, 3), (3, 4), |
| | (4, 1) | (2, 6), (1, 12) |
| | P_{CSIRS,r} = 12: (3, 2), | (8, 1), (4, 2), (2, 4), (1, 8) |
| | (6, 1) | |
| | P_{CSIRS,r} = 16: (4, 2), | (6, 1), (3, 2), (2, 3), (1, 6) |
| | (8, 1) | |
| | P_{CSIRS,r} = 24: (4, 3), | (4, 1), (2, 2), (1, 4) |
| | (6, 2), (12, 1) | |
| | P_{CSIRS,r} = 32: (4, 4), | (3, 1), (1, 3) |
| | (8, 2), (16, 1) | |
| 128 | P_{CSIRS,r} = 2: (1, 1) | (64, 1), (32, 2), (16, 4), (8, 8), |
| | | (4, 16), (2, 32), (1, 64) |
| | P_{CSIRS,r} = 4: (2, 1) | (32, 1), (16, 2), (8, 4), (4, 8) |
| | | (2, 16), (1, 32) |
| | P_{CSIRS,r} = 8: (2, 2), | (16, 1), (8, 2), (4, 4), |
| | (4, 1) | (2, 8)(1, 16) |
| | P_{CSIRS,r} = 16: | (8, 1), (4, 2), (2, 4), (1, 8) |
| | (4, 2), (8, 1) | |
| | P_{CSIRS,r} = 32: | (4, 1), (2, 2), (1, 4) |
| | (4, 4), (8, 2), (16, 1) | |
| | P_{CSIRS,r} = 64: (8, 4), | (2, 1), (1, 2) |
| | (16, 2), (32, 1) | |
| 36 | P_{CSIRS,r} = 2: (1, 1) | (18, 1), (9, 2), (6, 3), (3, 6), |
| | | (2, 9), (1, 18) |
| | P_{CSIRS,r} = 4: (2, 1) | (9, 1), (3, 3), (1, 9) |
| | P_{CSIRS,r} = 12: | (3, 1), (1, 3) |
| | (6, 1), (3, 2) | |
| 48 | P_{CSIRS,r} = 2: (1, 1) | (24, 1), (12, 2), (8, 3), |
| | | (3, 8)(2, 12), (1, 24) |
| | P_{CSIRS,r} = 4: (2, 1) | (12, 1), (6, 2), (4, 3), (3, 4), |
| | | (2, 6)(1, 12) |
| | P_{CSIRS,r} = | (6, 1), (3, 2), (2, 3), (1, 6) |
| | 8: (2, 2), (4, 1) | |
| | P_{CSIRS,r} = | (4, 1), (2, 2), (1, 4) |
| | 12: (4, 2), (8, 1) | |
| | P_{CSIRS,r} = | (3, 1), (1, 3) |
| | 16: (4, 2), (8, 1) | |
| | P_{CSIRS,r} = 24: (4, 3), | (2, 1), (1, 2) |
| | (6, 2)(12, 1) | |
| 72 | P_{CSIRS,r} = 2: (1, 1) | (36, 1), (18, 2), (9, 4), |
| | | (4, 9)(2, 18), (1, 36) |
| | P_{CSIRS,r} = 4: (2, 1) | (18, 1), (9, 2), (2, 9)(1, 18) |
| | P_{CSIRS,r} = | (9, 1), (3, 3), (1, 9) |
| | 8: (2, 2), (4, 1) | |
| | P_{CSIRS,r} = | (6, 1), (3, 2), (2, 3), (1, 6) |
| | 12: (4, 2), (8, 1) | |
| | P_{CSIRS,r} = | (4, 1), (2, 2), (1, 4) |
| | 16: (4, 2), (8, 1) | |
| | P_{CSIRS,r} = 24: (4, 3), | (3, 1), (1, 3) |
| | (6, 2), (12, 1) | |
| | P_{CSIRS,r} = 32: (4, 4), | (2, 1), (1, 2) |
| | (8, 2), (16, 1) | |

A UE can be configured with QCL assumptions (i.e., QCL source RS and QCL type) for a NZP CSI-RS resource as described in section 5.1.5 of TS 38.214, copied below.

### START: Section 5.1.5 of TS 38.214 [REF8]

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location relationship between one or two downlink reference signals and the DMRS ports of the PDSCH, the DMRS port of PDCCH or the CSI-RS port(s) of a CSI-RS resource. The quasi-co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi-co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJoint-TCIStateList in PDSCH-Config for providing a reference signal for the quasi co-location for DMRS of PDSCH and DMRS of PDCCH in a BWP/component carrier (CC), for CSI-RS, and to provide a reference, if applicable, for determining UL TX spatial filter for dynamic-grant and configured-grant based PUSCH and PUCCH resource in a BWP/CC, and SRS.

If the TCI-State or UL-TCI-State configurations are absent in a BWP of the CC, the UE can apply the TCI-State or UL-TCI-State configurations from a reference BWP of a reference CC. The UE is not expected to be configured with tci-StatesToAddModList, SpatialRelationInfo or PUCCH-SpatialRelationInfo, except SpatialRelationInfoPos in a CC in a band, if the UE is configured with dl-OrJoint-TCIStateList or UL-TCI-State in any CC in the same band. The UE can expect that when the UE is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with dl-OrJoint-TCIStateList or UL-TCI-State in any CC within the same band in the CC list.

The UE receives an activation command, as described in clause 6.1.3.14 of [10, TS 38.321] or 6.1.3.47 of [10, TS 38.321], used to map up to 8 transmission configuration indication (TCI) states and/or pairs of TCI states, with one TCI state for DL channels/signals and/or one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the activation command maps TCI-State and/or UL-TCI-State to only one TCI codepoint, the UE shall apply the indicated TCI-State and/or UL-TCI-State to one or to a set of CCs/DL BWPs, and if applicable, to one or to a set of CCs/UL BWPs once the indicated mapping for the one single TCI codepoint is applied as described in [11, TS 38.133].

When the bwp-id or cell for QCL-TypeA/D source RS in a QCL-Info of the TCI state is not configured, the UE assumes that QCL-TypeA/D source RS is configured in the CC/DL BWP where TCI state applies.

When tci-PresentInDCI is set as ‘enabled’ or tci-PresentDCI-1-2 is configured for the CORESET, a UE configured with dl-OrJoint-TCIStateList with activated TCI-State or UL-TCI-State receives DCI format 1_1/1_2 providing indicated TCI-State and/or UL-TCI-State for a CC or each of the CCs in the same CC list configured by simultaneousU-TCI-UpdateList1-r17, simultaneousU-TCI-UpdateList2-r17, simultaneousU-TCI-UpdateList3-r17, simultaneousU-TCI-UpdateList4-r17. The DCI format 1_1/1_2 can be with or without, if applicable, DL assignment. If the DCI format 1_1/1_2/ is without DL assignment, the UE can expect the following:
configured scheduling RNTI (CS-RNTI) is used to scramble the CRC for the DCI
The values of the following DCI fields are set as follows:
   RV=‘1’s
   MCS=‘1’s
   NDI=0
   Set to ‘0’s for frequency domain resource assignment (FDRA) Type 0, or ‘1’s for FDRA Type 1, or ‘0’s for dynamicSwitch (same as in Table 10.2-4 of [6, TS 38.213]).

### END: Section 5.1.5 of TS 38.214 [REF8]

### TCI-State Information Element

-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- |

Need R

| | |
|---|---|
| pathlossReferenceRS-Id-r17 | PUSCH-PathlossReferenceRS-Id-r17 |

OPTIONAL, -- Cond JointTCI

| | | |
|---|---|---|
| ul-powerControl-r17 | Uplink-powerControlId-r17 | OPTIONAL -- |

Cond JointTCI
]]
}

| QCL-Info ::= | SEQUENCE { | |
|---|---|---|
| cell | ServCellIndex | OPTIONAL, -- Need R |
| bwp-Id | BWP-Id | OPTIONAL, -- Cond CSI- |

RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

### QCL-Info Field Descriptions

bwp-Id: The DL BWP which the RS is located in.

cell: The UE's serving cell in which the referenceSignal is configured. If the field is absent, it applies to the serving cell in which the TCI-State is applied. The RS can be located on a serving cell other than the serving cell in which the TCI-State is configured only if the qcl-Type is configured as typeC or typeD. See TS 38.214 [REF8] clause 5.1.5.

referenceSignal: Reference signal with which quasi-collocation information is provided as specified in TS 38.214 [REF8] clause 5.1.5.

qcl-Type: QCL type as specified in TS 38.214 [REF8] [19] clause 5.1.5.

TABLE 3

| QCL-Info | QCL type = | | |
|---|---|---|---|
| for (target RS) | typeA/B/C | QCL type = typeD | Example |
| P-TRS (CSI-RS | typeC with | typeD with the | Q1 |
| with trs-info) | SS/PBCH | same SS/PBCH | |
| | typeC with | typeD with CSI-RS | Q2 |
| | SS/PBCH | with repetition ON | |
| AP-TRS (CSI-RS | typeA with | typeD with the | Q3 |
| with trs-info) | P-TRS | same P-TRS | |
| CSI-RS for CSI report | typeA with | typeD with the | Q4 |
| (CSI-RS without trs-info | TRS | same TRS | |
| and without repetition) | typeA with | typeD with | Q5 |
| | TRS | SS/PBCH | |
| | typeA with | typeD with CSI-RS | Q6 |
| | TRS | with repetition ON | |
| | typeB with | Not applicable | Q7 |
| | TRS | | |
| CSI-RS for beam report | typeA with | typeD with the | Q8 |
| (CSI-RS with repetition) | TRS | same TRS | |
| | typeA with | typeD with CSI-RS | Q9 |
| | TRS | with repetition ON | |
| | typeC with | typeD with the | Q10 |
| | SS/PBCH | same SS/PBCH | |

In one example, a NZP CSI-RS resource can be configured with at least one of the following QCL assumptions (summarized in Table 3).

In one example, for a periodic (P)-CSI-RS as TRS (aka P-TRS), the QCL type can be (typeC, typeD) as described herein.

For a periodic CSI-RS resource in an NZP-CSI-RS-ResourceSet configured with higher layer parameter trs-Info, the UE (e.g., the UE 116) shall expect that a TCI-State indicates one of the following quasi co-location type(s):
‘typeC’ with an synchronization signal/physical broadcast channel (SSB/PBCH) block and, when applicable, ‘typeD’ with the same SS/PBCH block where SS/PBCH block may have a physical cell ID (PCI) different from the PCI of the serving cell. The UE can expect center frequency, subcarrier spacing (SCS), single frequency network (SFN) offset are the same for SS/PBCH block from the serving cell and SS/PBCH block having a PCI different from the serving cell, or
‘typeC’ with an SS/PBCH block and, when applicable, ‘typeD’ with a CSI-RS resource in an NZP-CSI-RS-ResourceSet configured with higher layer parameter repetition, where SS/PBCH block may have a PCI different from the PCI of the serving cell. The UE can expect center frequency, SCS, SFN offset are the same for SS/PBCH block from the serving cell and SS/PBCH block having a PCI different from the serving cell.

For periodic/semi-persistent CSI-RS, if the UE is configured with dl-OrJoint-TCIStateList, the UE can expect that the indicated TCI-State is not applied.

In one example, for an aperiodic (AP)-CSI-RS as TRS (aka AP-TRS), the QCL type can be (typeA, typeD) as described herein.

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

In one example, a NZP CSI-RS resource can be configured for CSI reporting with report quantities including contents from (rank indicator (RI), precoding matrix indicator (PMI), channel quality indicator (CQI), CQI report interval (CRI), layer index (LI)) with QCL type=(typeA, typeD) or typeB (without typeD) as described herein.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource; or
‘typeA’ with a CSI-RS resource in a NZP-CSI-RS-ResourceSet configured with higher layer parameter trs-Info and, when applicable, ‘typeD’ with an SS/PBCH block, where SS/PBCH block may have a PCI different from the PCI of the serving cell. The UE can expect center frequency, SCS, SFN offset are the same for SS/PBCH block from the serving cell and SS/PBCH block having a PCI different from the serving cell; or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition; or
‘typeB’ with a CSI-RS resource in a NZP-CSI-RS-ResourceSet configured with higher layer parameter trs-Info when ‘typeD’ is not applicable.

In one example, a NZP CSI-RS resource can be configured for CSI/beam reporting with report quantities including contents from (LI, CRI, RI, CQI, PMI or CRI/synchronization signal block resource indicator (SSBRI), L1−reference signal received power (RSRP)/L1−signal to interference and noise ratio (SINR)/CapabilityIndex) with QCL type=(typeA, typeD) or (typeC, typeD) as described herein.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource; or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition; or
‘typeC’ with an SS/PBCH block and, when applicable, ‘typeD’ with the same SS/PBCH block, the reference RS may additionally be an SS/PBCH block having a PCI different from the PCI of the serving cell. The UE can expect center frequency, SCS, SFN offset are the same for SS/PBCH block from the serving cell and SS/PBCH block having a PCI different from the serving cell.

In this disclosure, several examples are provided for quasi-co-location (QCL) assumptions on K>1 NZP CSI-RS resources linked with a CSI reporting based on a codebook (e.g., via codebookType in IE CSI-ReportConfig).

The K NZP CSI-RS resources can be configured either via a CSI-ResourceConfig or via a NZP-CSI-RS-ResourceSet or via CSI-MeasConfig or via a CSI-ReportConfig (which can be the same as the one for the CSI reporting based on a codebook) or via a CSI-AperiodicTriggerStateList (e.g. when K NZP CSI-RS resources are AP or/and the CSI reporting is AP) or via a CSI-SemiPersistentOnPUSCH-TriggerStateList (e.g. when K NZP CSI-RS resources are SP or/and the CSI reporting is SP) or via new IE (different from the previously mentioned ones).

In one example, a precoder (or precoding matrix) for one (or multiple) layer(s) corresponds to a non-coherent joint transmission (NCJT) precoder when it is transmitted from or associated with one of the K NZP CSI-RS resources.

In one example, a precoder (or precoding matrix) for one (or multiple) layer(s) corresponds to a coherent joint transmission (CJT) precoder when it is transmitted from or associated with at least two of the K NZP CSI-RS resources.
In one example, a precoder (or precoding matrix) for one (or multiple) layer(s) is a full-CJT (F-CJT) when it is transmitted from or associated with the K NZP CSI-RS resources.
In one example, a precoder (or precoding matrix) for one (or multiple) layer(s) is a partial-CJT (P-CJT) when it is transmitted from or associated with N of the K NZP CSI-RS resources, where 2≤N<K.

In one embodiment, a UE is configured with K>1 NZP CSI-RS resources linked with a CSI report based on a codebook for P_{CSIRS}∈S ports (e.g., configured via codebookType in IE CSI-ReportConfig). The P_{CSIRS} is a total number of CSI-RS ports across K NZP CSI-RS resources. The value of P_{CSIRS} and P_{CSIRS,r} for each of the r=1, . . . , K CSI-RS resources are according to one of the examples described herein.

In one example, the codebook corresponds to a (low-resolution) Type I codebook, as described in this disclosure. An example of the Type I codebook can be similar to (or based on) one of the NR Type I codebooks, as described in Section 5.2.2.2.1 and 5.2.2.2.2 of TS 38.214, including their extensions to P_{CSIRS}>32 CSI-RS ports (as described in this disclosure).
In one example, the Type I codebook is a single panel codebook, i.e., CodebookType=typeI-SinglePanel (denoted as C1).
In one example, the Type I codebook is a multi-panel codebook, i.e., CodebookType=typeI-MultiPanel (denoted as C2).
In one example, the Type I codebook is a single panel or a multi-panel codebook, i.e., CodebookType=typeI-SinglePanel or typeI-MultiPanel.

In one example, the codebook corresponds to a (high-resolution) Type II codebook, as described in this disclosure. An example of the Type II codebook can be similar to (or based on) one of the NR Type II codebooks, as described in Section 5.2.2.2.3 through 5.2.2.2.11 of TS 38.214, including their extensions to P_{CSIRS}>32 CSI-RS ports (as described in this disclosure).
In one example, the Type II codebook is a regular Type II codebook, i.e., CodebookType=typeII (denoted as C3).
In one example, the Type II codebook is a Type II port selection codebook, i.e., CodebookType=typeII-PortSelection (denoted as C4).
In one example, the Type II codebook is a regular or a Type II port selection codebook, i.e., CodebookType=C3 or C4.
In one example, the Type II codebook is a regular enhanced Type II codebook, i.e., CodebookType=typeII-r16 (denoted as C5).
In one example, the Type II codebook is an enhanced Type II port selection codebook, i.e., CodebookType=typeII-PortSelection-r16 (denoted as C6).
In one example, the Type II codebook is a further enhanced Type II port selection codebook, i.e., CodebookType=typeII-PortSelection-r17 (denoted as C7).
In one example, the Type II codebook is a regular or a Type II port selection codebook, i.e., CodebookType=C5 or C6/C7.
In one example, the Type II codebook is a regular enhanced Type II CJT codebook, i.e., CodebookType=typeII-CJT-r18 (denoted as C8).
In one example, the Type II codebook is n further enhanced Type II CJT port selection codebook, i.e., CodebookType=typeII-CJT-PortSelection-r18 (denoted as C9).
In one example, the Type II codebook is C8 or C9, i.e., CodebookType=C8 or C9.
In one example, the Type II codebook is a regular enhanced Type II Doppler codebook, i.e., CodebookType=typeII-Doppler-r18 (denoted as C10).
In one example, the Type II codebook is n further enhanced Type II Doppler port selection codebook, i.e., CodebookType=typeII-Doppler-PortSelection-r18 (denoted as C11).
In one example, the Type II codebook is C10 or C11, i.e., CodebookType=C10 or C11.

In one example, the codebook can only be a Type I codebook, which can be fixed (according to at least one the examples described herein) or configured from one of the multiple supported Type I codebooks (from the examples described herein).

In one example, the codebook can only be a Type II codebook, which can be fixed (according to at least one the examples described herein) or configured from one of the multiple supported Type I codebooks (from the examples described herein).

In one example, the codebook corresponds to a (low-resolution) Type I codebook or a (high-resolution) Type II codebook, where Type 1 and Type II codebooks are according to at least one of the respective examples described herein. One of the two codebooks can be configured via higher layer (e.g., CodebookType). The Type I codebook can be fixed (according to at least one the examples described herein) or one of the multiple supported Type I codebooks (from the examples described herein). The Type II codebook can be fixed (according to at least one the examples described herein) or one of the multiple supported Type II codebooks (from the examples described herein).

In one example, the set S includes values P_{CSIRS}>32, e.g., S={64, 96, 128} or {48, 64, 96, 128}.

In one example, the set S includes values from {4, 8, 12, 16, 24, 32, 48, 64, 96, 128}.

In one example, when P_{CSIRS}≤32, the codebook is associated with CSI-RS ports in one CSI-RS resource.

In this case, either K=1 or K>1 and CRI indicates one of the K CSI-RS resources.

In one example, when P_{CSIRS}>32:
the codebook is associated with CSI-RS ports in one CSI-RS resource. In this case, either K=1 or K>1 and CRI indicates one of the K CSI-RS resources, and each CSI-RS resource is associated with P_{CSIRS}>32 ports.
the codebook is associated with CSI-RS ports aggregated across the K>1 CSI-RS resources.
the codebook is associated with CSI-RS ports aggregated across of K≥N≥1 CSI-RS resources.

In one embodiment, the QCL assumptions (i.e., QCL source RS and QCL type) for K>1 NZP CSI-RS resources can be the same/common, i.e., one common QCL assumption is used/configured for the K NZP CSI-RS resources. One of the motivations of the common/same QCL assumptions is that it can emulate one NZP CSI-RS resource behavior (as in common Type I codebooks) using K>1 NZP CSI-RS resources. Another motivation is that it can be facilitate a scalable NZP CSI-RS resource configuration for various use cases (co-located or non-co-located) and frequency bands (<1 GHz, FR1, mid band, 6-15 GHz, or FR2), and antenna architectures.

In one example, the same/common QCL (source RS and the QCL-type) can be according to one of the common QCL configurations as shown in Table 3.
In one example, the common QCL configurations correspond to only one of Q4-Q7, e.g., Q4.
In one example, the common QCL configurations correspond to two of Q4-Q7, e.g. (Q4,Q5) or (Q4,Q7).
In one example, the common QCL configurations correspond to three of Q4-Q7, e.g. (Q4, Q5, Q7) or (Q4, Q4, Q6).
In one example, the common QCL configurations correspond to Q4-Q7.
In one example, the common QCL configurations correspond to Q4-Q10.
In one example, the common QCL configurations correspond to Q1-Q10.

TABLE 4
Example of QCL-Info

| Example | Source RS | QCL type |
|---|---|---|
| R1 | SS/PBCH | TypeA |
| R2 | | TypeB |
| R3 | | TypeC |
| R4 | | TypeD |
| R5 | | TypeE |
| R6 | P-TRS | TypeA |
| R7 | | TypeB |
| R8 | | TypeC |
| R9 | | TypeD |
| R10 | | TypeE |
| R11 | TRS | TypeA |
| R12 | | TypeB |
| R13 | | TypeC |
| R14 | | TypeD |
| R15 | | TypeE |
| R16 | CSI-RS with repetition ON | TypeA |
| R17 | | TypeB |
| R18 | | TypeC |
| R19 | | TypeD |
| R20 | | TypeE |

In one example, the same/common QCL (source RS and the QCL-type) corresponds to only one QCL-Info (corresponding to one of the common QCL-types A/B/C/D), which can be according to one of the examples R1 through R20 shown in Table 4.
In one example, the only one QCL-Info is fixed and corresponds to typeA.
In one example, the only one QCL-Info is fixed and corresponds to typeB.
In one example, the only one QCL-Info is fixed and corresponds to typeC.
In one example, the only one QCL-Info is fixed and corresponds to typeD.
In one example, the only one QCL-Info is configured and corresponds to one of T1=(typeA,typeB).
In one example, the only one QCL-Info is configured and corresponds to one of T2=(typeA,typeC).
In one example, the only one QCL-Info is configured and corresponds to one of T3=(typeA,typeD).
In one example, the only one QCL-Info is configured and corresponds to one of T4=(typeB,typeC).
In one example, the only one QCL-Info is configured and corresponds to one of T5=(typeB,typeD).
In one example, the only one QCL-Info is configured and corresponds to one of T6=(typeC,typeD).
In one example, the only one QCL-Info is configured and corresponds to one of S1=(typeA, typeB, typeC).
In one example, the only one QCL-Info is configured and corresponds to one of S2=(typeA, typeB, typeD).
In one example, the only one QCL-Info is configured and corresponds to one of S3=(typeA, typeC, typeD).
In one example, the only one QCL-Info is configured and corresponds to one of S4=(typeB, typeC, typeD).
In one example, the only one QCL-Info is configured and corresponds to one of (typeA, typeB, typeC, typeD).

In one example, the same/common QCL (source RS and the QCL-type) includes two QCL-Infos (corresponding to two different QCL-types, from the common QCL-types A/B/C/D), each can be according to one of the examples R1 through R20 shown in Table 4. In one example, the source RS is the same for the two QCL-Infos. In one example, the source RSs are different for the two QCL-Infos. In one example, the source RSs can be the same or different for the two QCL-Infos.
In one example, the two QCL-Infos are fixed and corresponds to T1=(typeA,typeB).
In one example, the two QCL-Infos are fixed and corresponds to T2=(typeA,typeC).
In one example, the two QCL-Infos are fixed and corresponds to T3=(typeA,typeD).
In one example, the two QCL-Infos are fixed and corresponds to T4=(typeB,typeC).
In one example, the two QCL-Infos are fixed and corresponds to T5=(typeB,typeD).
In one example, the two QCL-Infos are fixed and corresponds to T6=(typeC,typeD).
In one example, the two QCL-Infos are configured and correspond to one of {T1,T2}.
In one example, the two QCL-Infos are configured and correspond to one of {T1,T3}.
In one example, the two QCL-Infos are configured and correspond to one of {T1,T4}.
In one example, the two QCL-Infos are configured and correspond to one of {T1,T5}.
In one example, the two QCL-Infos are configured and correspond to one of {T1,T6}.
In one example, the two QCL-Infos are configured and correspond to one of {T2,T3}.
In one example, the two QCL-Infos are configured and correspond to one of {T2,T4}.
In one example, the two QCL-Infos are configured and correspond to one of {T2,T5}.
In one example, the two QCL-Infos are configured and correspond to one of {T2,T6}.
In one example, the two QCL-Infos are configured and correspond to one of {T3,T4}.
In one example, the two QCL-Infos are configured and correspond to one of {T3,T5}.
In one example, the two QCL-Infos are configured and correspond to one of {T3,T6}.
In one example, the two QCL-Infos are configured and correspond to one of {T4,T5}.
In one example, the two QCL-Infos are configured and correspond to one of {T4,T6}.
In one example, the two QCL-Infos are configured and correspond to one of {T5,T6}.
In one example, the two QCL-Infos are configured and correspond to one of {T1, T2, T3}.
In one example, the two QCL-Infos are configured and correspond to one of {T1, T2, T4}.
In one example, the two QCL-Infos are configured and correspond to one of {T1, T2, T5}.
In one example, the two QCL-Infos are configured and correspond to one of {T1, T2, T6}.
In one example, the two QCL-Infos are configured and correspond to one of {T1, T3, T4}.
In one example, the two QCL-Infos are configured and correspond to one of {T1, T3, T5}.
In one example, the two QCL-Infos are configured and correspond to one of {T1, T3, T6}.
In one example, the two QCL-Infos are configured and correspond to one of {T1, T4, T5}.
In one example, the two QCL-Infos are configured and correspond to one of {T1, T4, T6}.
In one example, the two QCL-Infos are configured and correspond to one of {T1, T5, T6}.
In one example, the two QCL-Infos are configured and correspond to one of {T2, T3, T4}.
In one example, the two QCL-Infos are configured and correspond to one of {T2, T3, T5}.
In one example, the two QCL-Infos are configured and correspond to one of {T2, T3, T6}.
In one example, the two QCL-Infos are configured and correspond to one of {T2, T4, T5}.
In one example, the two QCL-Infos are configured and correspond to one of {T2, T4, T6}.
In one example, the two QCL-Infos are configured and correspond to one of {T2, T5, T6}.
In one example, the two QCL-Infos are configured and correspond to one of {T3, T4, T5}.
In one example, the two QCL-Infos are configured and correspond to one of {T3, T4, T6}.
In one example, the two QCL-Infos are configured and correspond to one of {T3, T5, T6}.
In one example, the two QCL-Infos are configured and correspond to one of {T4, T5, T6}.
In one example, the two QCL-Infos are configured and correspond to one of {T1, T2, T3, T4}.
In one example, the two QCL-Infos are configured and correspond to one of {T1, T2, T3, T5}.
In one example, the two QCL-Infos are configured and correspond to one of {T1, T2, T3, T6}.
In one example, the two QCL-Infos are configured and correspond to one of {T1, T2, T4, T5}.
In one example, the two QCL-Infos are configured and correspond to one of {T1, T2, T4, T6}.
In one example, the two QCL-Infos are configured and correspond to one of {T1, T2, T5, T6}.
In one example, the two QCL-Infos are configured and correspond to one of {T1, T3, T4, T5}.
In one example, the two QCL-Infos are configured and correspond to one of {T1, T3, T4, T6}.
In one example, the two QCL-Infos are configured and correspond to one of {T1, T3, T5, T6}.
In one example, the two QCL-Infos are configured and correspond to one of {T1, T4, T5, T6}.
In one example, the two QCL-Infos are configured and correspond to one of {T2, T3, T4, T5}.
In one example, the two QCL-Infos are configured and correspond to one of {T2, T3, T4, T6}.
In one example, the two QCL-Infos are configured and correspond to one of {T2, T3, T5, T6}.
In one example, the two QCL-Infos are configured and correspond to one of {T2, T4, T5, T6}.
In one example, the two QCL-Infos are configured and correspond to one of {T3, T4, T5, T6}.
In one example, the two QCL-Infos are configured and correspond to one of {T1, T2, T3, T4, T5}.
In one example, the two QCL-Infos are configured and correspond to one of {T1, T2, T3, T4, T6}.
In one example, the two QCL-Infos are configured and correspond to one of {T1, T2, T3, T5, T6}.
In one example, the two QCL-Infos are configured and correspond to one of {T1, T2, T4, T5, T6}.
In one example, the two QCL-Infos are configured and correspond to one of {T1, T3, T4, T5, T6}.
In one example, the two QCL-Infos are configured and correspond to one of {T2, T3, T4, T5, T6}.
In one example, the two QCL-Infos are configured and correspond to one of {T1, T2, T3, T4, T5, T6}.

In one example, the same/common QCL (source RS and the QCL-type) includes three QCL-Infos (corresponding to three different QCL-types, from the common QCL-types A/B/C/D,). Each can be according to one of the examples R1 through R20 shown in Table 4, where S1-S4 are defined herein. In one example, the source RS is the same for any two of the three QCL-Infos. In one example, the source RSs are different for any two of the three QCL-Infos. In one example, the source RSs can be the same or different for any two of the three QCL-Infos.
In one example, the three QCL-Infos are fixed and corresponds to S1.
In one example, the three QCL-Infos are fixed and corresponds to S2.
In one example, the three QCL-Infos are fixed and corresponds to S3.
In one example, the three QCL-Infos are fixed and corresponds to S4.
In one example, the three QCL-Infos are configured and correspond to one of {S1,S2}.
In one example, the three QCL-Infos are configured and correspond to one of {S1,S3}.
In one example, the three QCL-Infos are configured and correspond to one of {S1,S4}.
In one example, the three QCL-Infos are configured and correspond to one of {S2,S3}.
In one example, the three QCL-Infos are configured and correspond to one of {S2,S4}.
In one example, the three QCL-Infos are configured and correspond to one of {S3,S4}.
In one example, the three QCL-Infos are configured and correspond to one of {S1, S2, S3}.
In one example, the three QCL-Infos are configured and correspond to one of {S1, S2, S4}.
In one example, the three QCL-Infos are configured and correspond to one of {S1, S3, S4}.
In one example, the three QCL-Infos are configured and correspond to one of {S2, S3, S4}.
In one example, the three QCL-Infos are configured and correspond to one of {S1, S2, S3, S4}.

In one example, the same/common QCL (source RS and the QCL-type) includes one QCL-Info (corresponding to a new QCL-type, TypeE), each can be according to one of the corresponding four examples (R5, R10, R15, R20) as shown in Table 4. In one example, TypeE corresponds to a QCL-Type that links K>1 NZP CSI-RS resources together for CSI reporting via one joint codebook across K resources.

In one example, the same/common QCL (source RS and the QCL-type) includes two QCL-Infos (one common Type A/B/C/D and one new QCL-type, TypeE). Each can be according to one of the examples R1 through R20 shown in Table 4. In one example, TypeE replaces one of the two QCL-Infos in one or more examples described herein.

In one example, the same/common QCL (source RS and the QCL-type) includes three QCL-Infos (two common Type A/B/C/D and one new QCL-type, TypeE). Each can be according to one of the examples R1 through R20 shown in Table 4. In one example, TypeE replaces one of the three QCL-Infos in one or more examples described herein.

In one example, the same/common QCL (source RS and the QCL-type) includes four QCL-Infos (three common Type A/B/C/D and one new QCL-type, TypeE). Each can be according to one of the examples R1 through R20 shown in Table 4. In one example, TypeE replaces one of the four QCL-Infos in one or more examples described herein.

In one example, the UE is also configured with a CSI-IM resource set for interference measurement (e.g., via CSI-IM-ResourceSet) and is linked to the CSI report, explained herein, (e.g., the linking can be via CSI-ReportConfig). The CSI-IM resource set can include Z≥1 CSI-IM resources. the QCL assumption and QCLtype. In one example, Z=1. In one example, Z=K (one-to-one correspondence). In one example,
In one example, the QCL assumption and QCL-type for the Z CSI-IM resources can be the same/common across Z resources.
In one example, the QCL assumption and QCL-type for the Z CSI-IM resources can be the different/independent for each CSI-IM resource.

In one embodiment, a UE is configured with the K NZP CSI-RS resources for the CSI report based on the codebook, details as described herein, except that a subset of CSI-RS resources (comprising N out of K NZP CSI-RS resources) have the same/common QCL assumptions (according to at least one of the examples described herein). Here, N∈{1, . . . , K−1}. In one example N is fixed (e.g., 1), or configured (e.g., via higher layer parameter), or reported by the UE (e.g., via UCI parameter or UL MAC CE).

The QCL assumptions of the remaining K−N CSI-RS resources can be the same as common, i.e., they can be different/independent for each of the remaining CSI-RS resources. Or the QCL assumptions of the remaining K−N CSI-RS resources can be the same/common (but different from the one for N resources) or different, and are provided using common or a new mechanism.

In one example, the subset of CSI-RS resources can be fixed.
In one example, the subset corresponds to the first N NZP CSI-RS resources, which can be based on NZP CSI-RS resource IDs sorted in increasing or decreasing order.
In one example, the subset corresponds to the first N NZP CSI-RS resources in the CSI-RS resource set.

In one example, an information about the subset of CSI-RS resources can be configured. In one example, the information corresponds to a bitmap (sequence) of size K bits (one bit per resource). In one example, the information corresponds to a parameter indicating the subset of CSI-RS resources. In one example, the information corresponds to a list/pool/set of NZP CSI-RS resources or a list/pool/set of NZP CSI-RS resources IDs.
In one example, the information can be configured via higher layer parameter (RRC). In one example, the information can be included inside an existing higher layer IE such as NZP CSI-RS-resource, or NZP CSI-RS-resource set, or CSI-ResourceConfig, or CSI-ReportConfig or CSI-AperiodicTriggerStateList or CSI-SemiPersistentOnPUSCH-TriggerStateList, or QCL-Info, or TCI state. In one example, a new IE indicating the information can be defined.
In one example, the information can be configured via MAC CE. In one example, for AP CSI-RS/CSI reporting, the information can be provided/indicated via an existing MAC CE activation command that activates a subset of Ap-TriggerStates and maps them as codepoints of a DCI field in a DCI (e.g., UL-DCI that triggers the AP-CSI via CSI request field). In one example, for SP CSI-RS/CSI reporting, the information can be provided/indicated via an existing MAC CE activation command that activates a subset of TriggerStates and maps them as codepoints of a DCI field in a DCI (e.g., UL-DCI that triggers the SP-CSI via CSI request field). In one example, a new MAC CE indicating the information can be defined.
In one example, the information can be configured via a DCI.
   In one example, the DCI is a DL-DCI (e.g., format 1_1, 1_2). In one example, the information can be included inside an existing DCI field (e.g., TCI State), or a new DCI field.
   In one example, the DCI is a UL-DCI (e.g., format 0_0, 0_1, 0_2). In one example, the information can be included inside an existing DCI field (e.g., CSI request field), or a new DCI field.
In one example, the information can be configured via a combination of MAC CE and DCI. For instance, a MAC CE can activate up to a fixed number (say Y) of CSI-RS resources, and a DCI can then indicate N CSI-RS resources.

In one example, an information about the subset of CSI-RS resources can be reported by the UE (e.g., the UE 116). In one example, the information is included in a UCI (e.g., one-part UCI on PUCCH or two-part UCI on PUCCH/PUSCH). Parameter. In one example, the information is included in a UL MAC CE (e.g., an existing UL MAC CE such as MAC CE for PHR-Config, or a new UL MAC CE).

In one embodiment, a UE is configured with the K NZP CSI-RS resources for the CSI report based on the codebook, details as described herein, except that either (a) the K CSI-RS resources have the same/common QCL assumptions (as described in one or more embodiments described herein), or (b) a subset of CSI-RS resources (comprising N out of K NZP CSI-RS resources) have the same/common QCL assumptions (as described one or more embodiments described herein). In one example, a parameter is used to configure/indicate one of the QCL assumptions (a) and (b).
In one example, this parameter can be configured via higher layer RRC (e.g., via NZP CSI-RS-resource, or NZP CSI-RS-resource set, or CSI-ResourceConfig, or CSI-ReportConfig, or CSI-AperiodicTriggerStateList or CSI-SemiPersistentOnPUSCH-TriggerStateList, or QCL-Info, or TCI state).
In one example, this parameter can be configured via MAC CE.
In one example, this parameter can be configured via DCI (e.g., DL-DCI or UL-DCI).

In one embodiment, for AP CSI-RS/CSI reporting according to the codebook described herein, a restriction can be enabled in CSI-AperiodicTriggerState definition. Likewise, for SP CSI-RS/CSI reporting according to the codebook described herein, a restriction can be enabled in CSI-SemiPersistentTriggerState definition.
In one example, the restriction corresponds to the same/common QCL assumptions for K>1 NZP CSI-RS resources (e.g., in one CSI resource set).
In one example, a pool of X>K NZP CSI-RS resources (e.g., in one CSI resource set) can be partitioned into M≥1 subsets of NZP CSI-RS resources, each subset comprising K NZP CSI-RS resources and have the same/common QCL assumptions. One of the M subsets can be activated/indicated via a MAC CE or/and DCI. Or a MAC CE can activate ≥1 subsets, and when >1 subsets are activated, one of the activated subsets can be indicated via a DCI indicates.

In one embodiment, for AP CSI-RS/CSI reporting according to the codebook described herein, the QCL-Info for each AP CSI-RS resource is either not provided in CSI-AperiodicTriggerState, or is ignored (if provided), and the common/same QCL assumption is provided via MAC CE or DCI instead. Likewise, for SP CSI-RS/CSI reporting according to the codebook described herein, the QCL-Info for each SP CSI-RS resource is either not provided in CSI-Semi-PersistentTriggerState, or is ignored (if provided), and the common/same QCL assumption is provided via MAC CE or DCI instead.
In one example, the common/same QCL assumption is provided via indicting a TCI state in DL-DCI. In one example, the TCI state can be provided jointly with a TCI field (Rel. 15 or Rel. 17 uTCI). In one example, the TCI state can be provided with a new DCI field. In one example, the TCI state can be provided with an unused DCI field or codepoints. In one example, such an indication is provided when higher layer parameter tciPresentInDCI or commonTciPresentInDCI is enabled.
In one example, the common/same QCL assumption is provided via indicting a TCI state in UL-DCI. In one example, the TCI state can be provided jointly with the CSI request field. In one example, the TCI state can be provided with a new DCI field. In one example, the TCI state can be provided with an unused DCI field or codepoints. In one example, such an indication is provided when higher layer parameter tciPresentInDCI or commonTciPresentInDCI is enabled.
In one example, the common/same QCL assumption is provided via indicting a TCI state in MAC CE.
In one example, the common/same QCL assumption is provided via a TCI state in a combination of MAC CE and DCI. For instance, MAC CE can activate ≥1 TCI states, and when >1 TCI states are activated, one of the activated TCI states can be indicated via a DCI.

In one embodiment, for P CSI-RS resources and P/AP/SP-CSI reporting according to the codebook described herein, a restriction can be enabled in CSI-AperiodicTriggerState or in CSI-SemiPersistentTriggerState or in NZP-CSI-RS-Resource-Set.
In one example, the restriction corresponds to the same/common QCL assumptions for K>1 NZP CSI-RS resources (e.g., in one CSI resource set).
In one example, a pool of X>K NZP CSI-RS resources (e.g., in one CSI resource set) can be partitioned into M≥1 subsets of NZP CSI-RS resources, each subset comprising K NZP CSI-RS resources and have the same/common QCL assumptions. One of the M subsets can be activated/indicated via a MAC CE or/and DCI. Or a MAC CE can activate ≥1 subsets, and when >1 subsets are activated, one of the activated subsets can be indicated via a DCI.

In one embodiment, for P CSI-RS resources and P/AP/SP-CSI reporting according to the codebook described herein, the QCL-Info for each P CSI-RS resource is either not provided via qcl-InfoPeriodicCSI-RS in IE NZP-CSI-RS-Resource, or is ignored (if provided), and the common/same QCL assumption is provided via MAC CE or DCI instead.
In one example, the common/same QCL assumption is provided via indicting a TCI state in DL-DCI. In one example, the TCI state can be provided jointly with a TCI field (Rel. 15 or Rel. 17 uTCI). In one example, the TCI state can be provided with a new DCI field. In one example, the TCI state can be provided with an unused DCI field or codepoints. In one example, such an indication is provided when higher layer parameter tciPresentInDCI or commonTciPresentInDCI is enabled.
In one example, the common/same QCL assumption is provided via indicting a TCI state in UL-DCI. In one example, the TCI state can be provided jointly with the CSI request field. In one example, the TCI state can be provided with a new DCI field. In one example, the TCI state can be provided with an unused DCI field or codepoints. In one example, such an indication is provided when higher layer parameter tciPresentInDCI or commonTciPresentInDCI is enabled.
In one example, the common/same QCL assumption is provided via indicting a TCI state in MAC CE.
In one example, the common/same QCL assumption is provided via a TCI state in a combination of MAC CE and DCI. For instance, MAC CE can activate ≥1 TCI states. When >1 TCI states are activated, one of the activated TCI states can be indicated via a DCI.

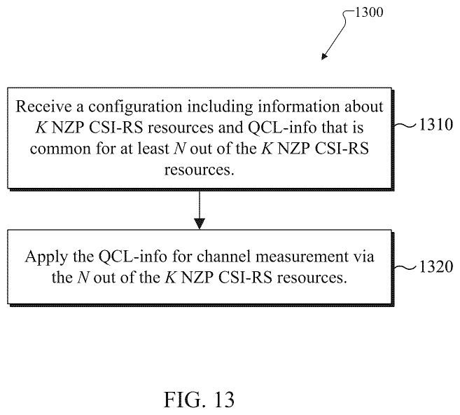

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE receiving a configuration including information about K>1 NZP CSI-RS resources and QCL-info that is common for at least N out of the K NZP CSI-RS resources (1310). For example, in 1310, 1<N≤K, the QCL-info indicates at least one source RS and a QCL-Type, and the QCL-Type indicates at least one channel property of the at least one source RS. The UE then, applies the QCL-info for channel measurement via the N out of the K NZP CSI-RS resources (1320). For example, in 1320, the UE determines to apply the QCL-info based on the configuration. In various embodiments, the channel measurement is based on an assumption that at least one channel property of the N NZP CSI-RS resources is same as the indicated at least one channel property of the at least one source RS.

In various embodiments, the UE may also receive a configuration about a CSI report, determine the CSI report based on a codebook associated with P_{CSIRS} CSI-RS ports aggregated across the K NZP CSI-RS resources, and transmit the CSI report.

In various embodiments, the configuration includes information about a TD behavior of the K NZP CSI-RS resources as being periodic, SP, or AP, the configuration includes an ID of a set NZP-CSI-RS-Resource-Set and the set includes IDs of the K NZP CSI-RS resources, and an ID of the QCL-info. For example, when the TD behavior is periodic, each NZP CSI-RS resource in the set does not include a separate QCL-info or includes the separate QCL-info, and when the separate QCL-info is included, the UE ignores the separate QCL-info or over-rides the separate QCL-info.

In various embodiments, the QCL-Type is one of Type A, where the at least one channel property includes Doppler shift, Doppler spread, average delay, and delay spread; Type B, where the at least one channel property includes Doppler shift and Doppler spread; Type C, where the at least one channel property includes Doppler shift and average delay; or Type D, where the at least one channel property includes Spatial Rx parameter. In various embodiments, the when the at least one source RS is a NZP CSI-RS resource with a higher layer parameter trs-info, the QCL-Type is Type A or Type B; and when the at least one source RS is a synchronization signal block (SSB), the QCL-Type is Type C.

In various embodiments, the configuration includes information about a second QCL-info with a second QCL-Type that is different from the QCL-Type of the QCL-info, and a source RS that is same or different from a source of the QCL-info.

In various embodiments, the when N=K, the QCL-info is common for all of the K NZP CSI-RS resources, when N<K, the QCL-info is common for the N NZP CSI-RS resources, and for the remaining K−N NZP CSI-RS resources, a second QCL-info common for all of the K−N NZP CSI-RS resources is provided or a second QCL-info for each of the K−N NZP CSI-RS resources is provided.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration including information about (i) K>1 non-zero power (NZP) channel state information-reference signal (CSI-RS) resources and (ii) quasi-co-location information (QCL-info) that is common for at least N out of the K NZP CSI-RS resources, where 1<N≤K, wherein the QCL-info indicates at least one source RS and a QCL-Type and wherein the QCL-Type indicates at least one channel property of the at least one source RS; and
a processor operably coupled to the transceiver, the processor, based on the configuration, configured to apply the QCL-info for channel measurement via the N out of the K NZP CSI-RS resources based on an assumption that at least one channel property of the N NZP CSI-RS resources is same as the indicated at least one channel property of the at least one source RS.

2. The UE of claim 1, wherein:
the transceiver is further configured to:
receive a configuration about a channel state information (CSI) report, and
transmit the CSI report, and
the processor is further configured to determine the CSI report based on a codebook associated with P_{CSIRS} CSI-RS ports aggregated across the K NZP CSI-RS resources.

3. The UE of claim 1, wherein:
the configuration includes information about a time domain (TD) behavior of the K NZP CSI-RS resources as being periodic, semi-persistent (SP), or aperiodic (AP),
the configuration includes an identifier (ID) of a set NZP-CSI-RS-Resource-Set and the set includes IDs of the K NZP CSI-RS resources, and an ID of the QCL-info,
when the TD behavior is periodic, each NZP CSI-RS resource in the set does not include a separate QCL-info or includes the separate QCL-info, and
when the separate QCL-info is included, the processor is configured to (i) ignore the separate QCL-info or (ii) over-ride the separate QCL-info.

4. The UE of claim 1, wherein the QCL-Type is one of:
Type A, where the indicated at least one channel property includes Doppler shift, Doppler spread, average delay, and delay spread,
Type B, where the indicated at least one channel property includes Doppler shift and Doppler spread,
Type C, where the indicated at least one channel property includes Doppler shift and average delay, or
Type D, where the indicated at least one channel property includes Spatial Rx parameter.

5. The UE of claim 4, wherein:
when the at least one source RS is a NZP CSI-RS resource with a higher layer parameter trs-info, the QCL-Type is Type A or Type B, and
when the at least one source RS is a synchronization signal block (SSB), the QCL-Type is Type C.

6. The UE of claim 1, wherein the configuration includes information about a second QCL-info with:
a second QCL-Type that is different from the QCL-Type of the QCL-info, and
a source RS that is same or different from a source of the QCL-info.

7. The UE of claim 1, wherein:
when N=K, the QCL-info is common for all of the K NZP CSI-RS resources,
when N<K, the QCL-info is common for the N NZP CSI-RS resources, and
for the remaining K−N NZP CSI-RS resources,
a second QCL-info common for all of the K−N NZP CSI-RS resources is provided, or
a second QCL-info for each of the K−N NZP CSI-RS resources is provided.

8. A base station (BS) comprising:
a processor; and
a transceiver operably coupled to the processor, the transceiver configured to transmit a configuration including information about (i) K>1 non-zero power (NZP) channel state information-reference signal (CSI-RS) resources and (ii) quasi-co-location information (QCL-info) that is common for at least N out of the K NZP CSI-RS resources, where 1<N≤K,
wherein the QCL-info indicates at least one source RS and a QCL-Type,
wherein the QCL-Type indicates at least one channel property of the at least one source RS, and
wherein the configuration indicates to apply the QCL-info for channel measurement via the N out of the K NZP CSI-RS resources based on an assumption that at least one channel property of the N NZP CSI-RS resources is same as the indicated at least one channel property of the at least one source RS.

9. The BS of claim 8, wherein the transceiver is further configured to:
transmit a configuration about a channel state information (CSI) report, and
receive the CSI report that is based on a codebook associated with P_{CSIRS} CSI-RS ports aggregated across the K NZP CSI-RS resources.

10. The BS of claim 8, wherein:
the configuration includes information about a time domain (TD) behavior of the K NZP CSI-RS resources as being periodic, semi-persistent (SP), or aperiodic (AP),
the configuration includes an identifier (ID) of a set NZP-CSI-RS-Resource-Set and the set includes IDs of the K NZP CSI-RS resources, and an ID of the QCL-info,
when the TD behavior is periodic, each NZP CSI-RS resource in the set does not include a separate QCL-info or includes the separate QCL-info, and
when the separate QCL-info is included, the separate QCL-info is ignored or over-ridden.

11. The BS of claim 8, wherein the QCL-Type is one of:
Type A, where the indicated at least one channel property includes Doppler shift, Doppler spread, average delay, and delay spread,
Type B, where the indicated at least one channel property includes Doppler shift and Doppler spread,
Type C, where the indicated at least one channel property includes Doppler shift and average delay, or
Type D, where the indicated at least one channel property includes Spatial Rx parameter.

12. The BS of claim 11, wherein:
when the at least one source RS is a NZP CSI-RS resource with a higher layer parameter trs-info, the QCL-Type is Type A or Type B, and
when the at least one source RS is a synchronization signal block (SSB), the QCL-Type is Type C.

13. The BS of claim 8, wherein the configuration includes information about a second QCL-info with:
a second QCL-Type that is different from the QCL-Type of the QCL-info, and
a source RS that is same or different from a source of the QCL-info.

14. The BS of claim 8, wherein:
when N=K, the QCL-info is common for all of the K NZP CSI-RS resources,
when N<K, the QCL-info is common for the N NZP CSI-RS resources, and
for the remaining K−N NZP CSI-RS resources,
a second QCL-info common for all of the K−N NZP CSI-RS resources is provided, or
a second QCL-info for each of the K−N NZP CSI-RS resources is provided.

15. A method performed by a user equipment, the method comprising:
receiving a configuration including information about (i) K>1 non-zero power (NZP) channel state information-reference signal (CSI-RS) resources and (ii) quasi-co-location information (QCL-info) that is common for at least N out of the K NZP CSI-RS resources, where 1<N≤K, wherein the QCL-info indicates at least one source RS and a QCL-Type and wherein the QCL-Type indicates at least one channel property of the at least one source RS; and
based on the configuration, applying the QCL-info for channel measurement via the N out of the K NZP CSI-RS resources based on an assumption that at least one channel property of the N NZP CSI-RS resources is same as the indicated at least one channel property of the at least one source RS.

16. The method of claim 15, further comprising:
receiving a configuration about a channel state information (CSI) report;
transmitting the CSI report; and
determining the CSI report based on a codebook associated with P_{CSIRS} CSI-RS ports aggregated across the K NZP CSI-RS resources.

17. The method of claim 15, wherein:
the configuration includes information about a time domain (TD) behavior of the K NZP CSI-RS resources as being periodic, semi-persistent (SP), or aperiodic (AP),
the configuration includes an identifier (ID) of a set NZP-CSI-RS-Resource-Set and the set includes IDs of the K NZP CSI-RS resources, and an ID of the QCL-info,
when the TD behavior is periodic, each NZP CSI-RS resource in the set does not include a separate QCL-info or includes the separate QCL-info, and
when the separate QCL-info is included, the separate QCL-info is ignored or over-ridden.

18. The method of claim 15, wherein the QCL-Type is one of:
Type A, where the indicated at least one channel property includes Doppler shift, Doppler spread, average delay, and delay spread,
Type B, where the indicated at least one channel property includes Doppler shift and Doppler spread,
Type C, where the indicated at least one channel property includes Doppler shift and average delay, or
Type D, where the indicated at least one channel property includes Spatial Rx parameter.

19. The method of claim 18, wherein:
when the at least one source RS is a NZP CSI-RS resource with a higher layer parameter trs-info, the QCL-Type is Type A or Type B, and
when the at least one source RS is a synchronization signal block (SSB), the QCL-Type is Type C.

20. The method of claim 15, wherein the configuration includes information about a second QCL-info with:
a second QCL-Type that is different from the QCL-Type of the QCL-info, and
a source RS that is same or different from a source of the QCL-info.
